(19) United States
(12) Patent Application Publication
(10) Pub. No.: US 2004/0053602 A1
(43) Pub. Date: Mar. 18, 2004

(54) Low-cost interoperable wireless multi-application and messaging service

(76) Inventor: Francis L. Wurzburg, Penfield, NY (US)

Correspondence Address: Thomas R. FitzGerald, Esq., Suite 210, 16 E. Main St., Rochester, NY, 14614-1803, US

(21) Appl. No.: 10/245,985

(22) Filed: Sep. 18, 2002

(51) Int. Cl. H04Q 7/20; H04B 7/00

(52) U.S. Cl. 455/412.1; 455/515; 455/422.1; 455/414.1

(57) ABSTRACT

A range of wireless data services is provided utilizing a thin client portable wireless component, a fixed access point component with client session and connection control and end applications for the client, and a service management component providing user profiles and authentication. Access point components and service management components interconnect via the existing broadband infrastructure. Cellular technologies, unlicensed spectrum, wireless LAN, and N-tier thin-client architectures are integrated, thereby reducing sharply the cost of delivering wireless email, instant messaging services, and multi-tier applications to consumers and business users.

### FIELD OF THE INVENTION

The invention relates to wireless communication systems, and more specifically to handheld portable wireless systems and their access points.

### BACKGROUND OF THE INVENTION

The ability to send and receive text messages using portable wireless devices is termed “anywhere” messaging. The demand for this capability is growing rapidly. Several vendors have produced wireless messaging solutions in the form of devices and software that attempt to provide the capability. All of these solutions suffer from three critical restrictions to their growth. First, they all operate over expensive, licensed wireless spectrum. Second, they all operate over equally expensive wireless infrastructures. Third, they are generally single-service offerings with very limited interoperability or worldwide roaming capability.

Third-generation systems (3G) constitute a unifying technology for the wireless experience of the future, but these systems face critical obstacles. First, 3G must amortize massive license and infrastructure costs. Second, there are two competing 3G standards: UMTS and CDMA2000. Such competition can result in a situation comparable to the GSM/CDMA problem in cellular telephony, where a user must carry two instruments, or one expensive instrument, in order to communicate freely over the available wireless networks.

Another technology, called “2.5G” builds on the existing wireless infrastructure, but lacks universality.

A further obstacle to the adoption of “anywhere” messaging is the requirement for a growing variety of highly-flexible applications to be supported for portable wireless devices. While a broad range of applications makes the wireless devices attractive to potential users, the need for supporting software and hardware drives up the cost and size of the device, offsetting or nullifying entirely the device's attractiveness. Providing numerous and easily-reconfigured applications in an inexpensive, compact portable wireless device via a readily-available and inexpensive network presents providers with a major challenge.

### GLOSSARY

AHP—access (point) host processor, situated at an access point

BISP—broadband ISP

CMTS—cable modem termination system

DSL—digital subscriber line

DSLAM—DSL access multiplexer

GPRS—general packet radio service

G.SHDSL—(global) symmetric high-bit-rate DSL

HLR—home location register

IM—instant messaging

LAN—local area network

MAC—medium access control (protocol layer)

MSA—metropolitan service area

MSO—multi-system operator

PDA—personal digital assistant (device)

PHY—physical access (control) (protocol layer)

PMU—personal messaging unit

RAU—relay administration unit

SIM—Subscriber Identification Module

SMS—short message service

SPIF—(a payment to reseller for a sale) thin client—a client program which uses a minimum of system resources

UMTS—Universal Mobile Telecommunications System

WAN—wide area network

WPAN—wireless personal area network

3G—third-generation (refers to software, firmware, and hardware in wireless telecommunications)

### SUMMARY OF THE INVENTION

The invention provides wireless data services utilizing a thin client portable wireless component, a fixed access point component with client session and connection control and end applications for the client, and a service management component providing user profiles and authentication. Access point components and service management components interconnect via the existing broadband infrastructure. The invention integrates cellular, unlicensed spectrum, wireless LAN, and N-Tier thin-client architectures, thereby reducing sharply the cost of delivering wireless email, instant messaging services, and multi-tier applications to consumers and business users.

### BRIEF DESCRIPTION OF THE DRAWINGS

FIG. 1 shows the invention's network of components and their connections.

FIG. 2 shows the invention's PMU, AHP, and RAU, their key software and data components, and their connections.

FIG. 2A shows the invention's AHP and its key software and data components.

FIG. 2B shows the invention's PMU and its key software and data components.

FIG. 3 shows a PMU diagram displaying possible physical configurations with multiple plug-in optional components.

FIG. 4 shows PMUs communicating via a shared AHP.

FIG. 5 shows PMUs communicating via multiple AHPs over a single network.

FIG. 6 shows PMUs communicating via multiple AHPs over multiple networks.

FIG. 7 shows a PMU connecting to databases on the Internet.

FIG. 8 shows many PMUs connecting to a server system in parallel with many client PCs.

FIG. 9 shows the access host processor steps in initiating service for a wireless user.

FIG. 10 shows the access host processor steps in establishing a user session.

FIG. 11 shows the access host processor steps in retrieving a user profile.

FIG. 12 shows the access host processor steps in executing a user session.

### DETAILED DESCRIPTION OF THE INVENTION

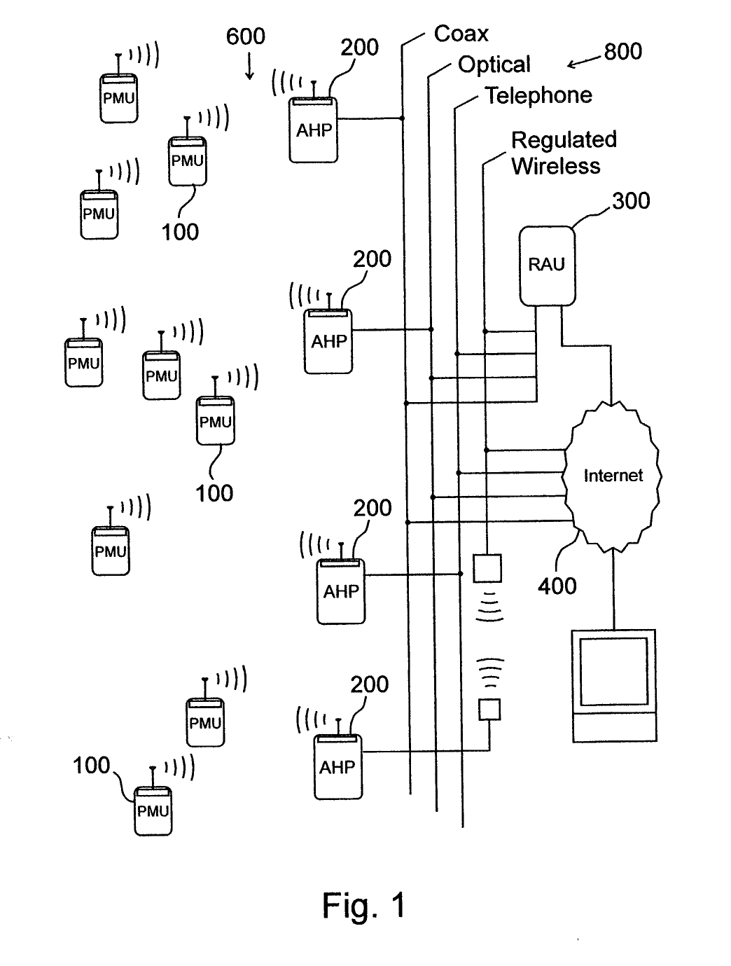

The invention is a suite of wireless communication and applications software programs operating on a network of interconnected computers. See FIG. 1. The invention's network comprises one or more simple personal messaging devices (PMUs) 100 for end users, one or more access host processors (AHPs) 200 at each access point connected wirelessly to the personal messaging devices 100 and via broadband networks 800 to other access host processors 200, and one or more relay administration units (RAUs) 300 connected via broadband networks 800 to the access host processors 200. The invention's connections between personal messaging devices 100 and access host processors 200 combine unlicensed wireless radio frequency spectrum, IEEE 802.11 (LAN/WAN) and 802.15 (WPAN) standard protocols, and cellular operational-support technologies. The invention's interconnected access host processors 200 and relay administration devices 300 comprise peer-to-peer computers operably linked viabroadband Internet connections 400.

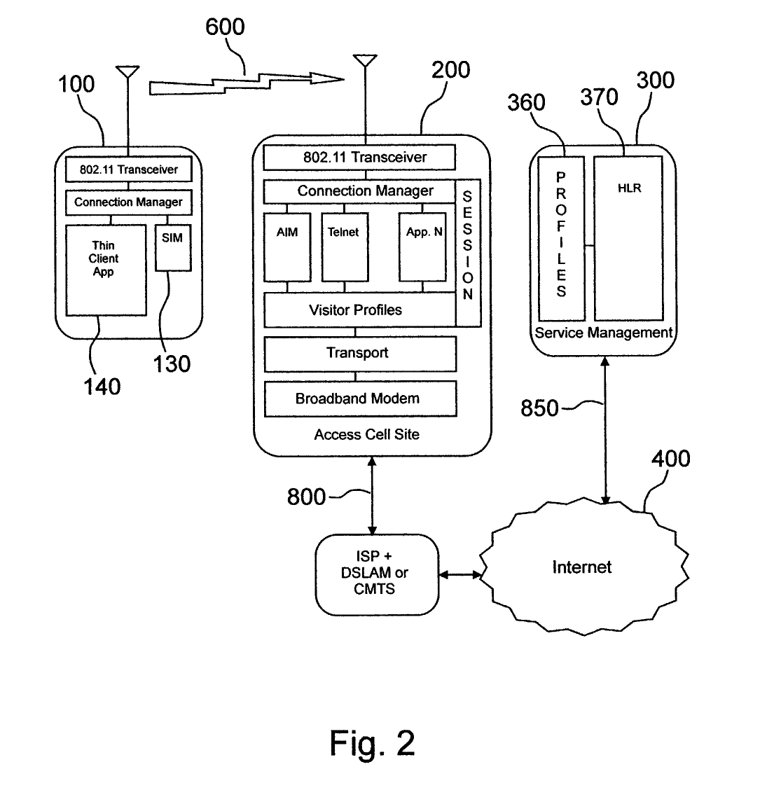

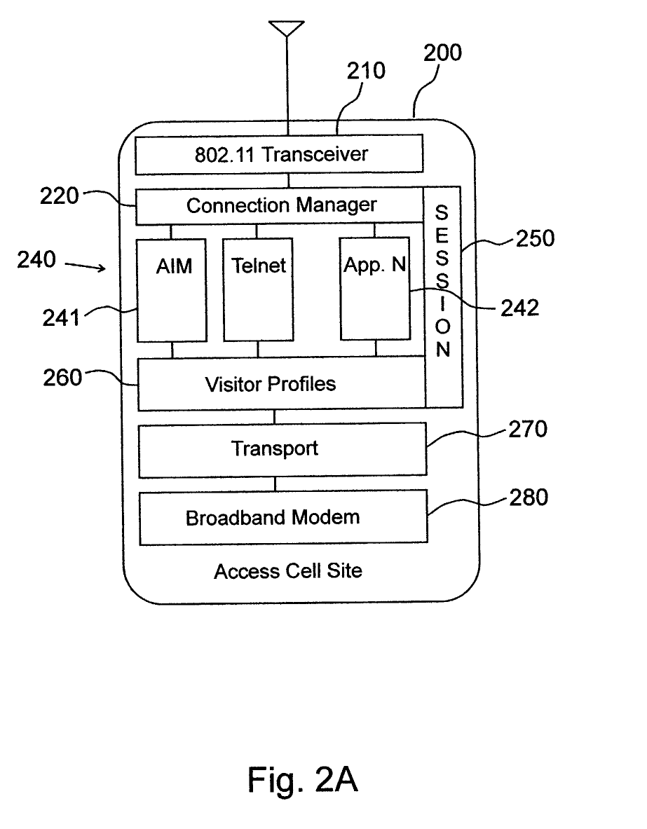

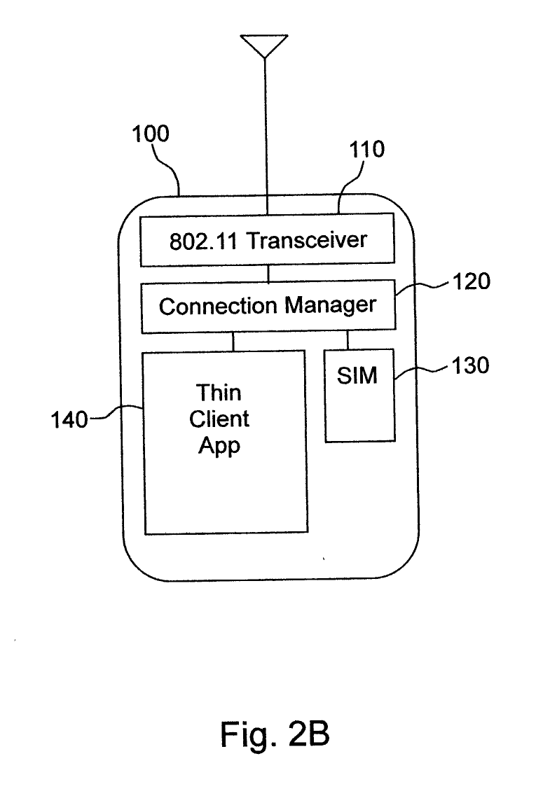

The invention's software comprises a suite of low cost, interoperable wireless applications and messaging services for the PMU user, operating over available wireless and broadband networks. The invention incorporates a low cost messaging and broadcast system that melds the least expensive parts of wireless and wired technologies. See FIG. 2. By placing a simple user interface and thin client software 140 in each PMU 100, and placing all the applications using that interface in the AHPs 200, the invention enables maximum simplification of the PMU wireless devices 100 carried by the end users of the service. For the end-user-to-access-point connection 600, the invention uses unregulated wireless spectrum to carry low bandwidth messages, primarily text. For its connections 800 among access points, and the connections 850 between access points 200 and the invention's service management system 300, the invention uses the cable broadband network and the Internet 400 to deliver large volumes of messages rapidly world-wide.

Enabling Components

The invention incorporates four enabling components to support its services to users: unlicensed wireless spectrum, ubiquitous broadband access, N-tier peer-to-peer architecture of applications, and operational systems support as implemented for cellular technologies.

To connect the personal messaging devices to its network, the invention uses unlicensed wireless radio spectrum with open MAC layer protocol stacks and low-cost hardware and software, providing worldwide interoperability with other systems. The invention's use of unlicensed wireless spectrum in the 902-928 MHz, 2400-2483.5 MHz, and 5725-5850 MHz frequency bands provides ubiquitous connectivity to the invention's personal messaging devices. The invention mixes and matches wireless MAC and PHY layers to produce optimum coverage with low power requirements.

To link its access host processors and its relay administration units, the invention uses broadband connectivity as widely available within the top 100 MSAs via cable MSOs operating as broadband ISPs, via DSL, or via campus-wide Ethernet backbones. The invention leverages this connectivity at low cost to provide connectivity to the Internet backbone via CMTSs, DSLAMs, or Ethernet connections.

The invention's ability to distribute shared computing resources widely provides two advantages. By placing intelligence at the point of wireless access (the AHP), the access host processors themselves are utilized to run client messaging applications in an N-Tier fashion, making them into a unique type of “smart cell tower”. The invention's placement of applications in the AHP provides for future advances and changes in services, and provides for a low cost, thin client wireless device (the PMU), supporting multiple concurrent applications including messaging. In addition, the peer-to-peer computing resources of the invention's access host processors provide a distributed signaling layer to facilitate network services such as roaming and session management. Cellular technologies provide the invention's Service Management and Operational Support Systems (SMS/OSS). The invention utilizes common North American and other wireless Operational Support Systems to support its infrastructure for service and network management, billing and customer care, and activation. Service Management comprises all the elements required to manage the user connectivity and transactions. It performs the following functions, among others:

User authentication

Session Initiation

Handoff management

User Profile storage and update

Connection to Operational Support Systems for billing, customer care, etc.

The most important of these functions with respect to the invention is the management and storage of user profiles, which allow comprehensive service application customization on a per-user basis. The user maintains these profiles using a secure transaction capability which provides breadth and flexibility of services creation and management.

Access Host Processor

The invention's access host processor or relay device unit (commonly called a cell site, base station, or an Access Point in 802.11 terminology) comprises a cable or DSL modem or other high-speed access connection for connection to a broadband network, a single board PC computer connected to the modem for execution of software applications, and a modified 802.15 transceiver connected to the computer. The modem, the computer, and the transceiver are contained in a weatherproof housing and equipped with a small (18″-48″) vertical antenna. The weatherproof housing is approximately half the size of a pizza box. It is designed to be mounted on telephone poles or other structures and can be powered either by 48VAC CATV power or by 120-240VAC public utility power. These sites are provisioned cheaply on any cable or other broadband “outside plant” facilities. It is easily possible to place the access point indoors and mount the antenna out of doors with a coaxial connector.

The access host processor's computer comprises a processor, a memory connected to the processor, a storage subsystem connected to the processor and the memory, and one or more communications subsystems connected to the processor and the memory. See FIG. 2A. The access host processor 200 runs a connection manager program 220 for validating, opening, and closing connections to PMUs; a session manager program 250 for opening, maintaining, and closing sustained connections with PMUs; a visitor profile register 260 for identifying PMU users connected with the AHP 200; a transport layer program 270 for moving information via the access host processor's broadband connection; a messaging program 241 for receiving, storing, forwarding, retrieving, managing, and sending PMU user messages; and one or more additional client application programs 242. Via its transceiver 210, the access host processor 200 provides wireless connectivity for PMUs to the worldwide network, and appears to remote Internet hosts as a fully-capable client PC.

Each access host processor 200 is connected to a broadband communication network, such as coaxial cable, optical fiber, regulated wireless, switched-access telephone network, or Ethernet, via a broadband modem 280 or direct connector. Each access host processor's transceiver 210 communicates with the PMUs. Each access host processor 200 has a range of reception that may or may not overlap other that of other access host processors.

The invention incorporates a subscriber profile register connected to the access host processor 200, the subscriber profile register selected to authenticate the PMU's subscriber identification module to: 1) permit sustained communication between the host access processor 200 and the PMU, 2) populate the visitor profile register 260 in the AHP 200 with the PMU's subscriber specific data, and 3) create on the access host processor 200 a virtual instance of the interactive data application corresponding to the populated visitor profile register 260. See FIG. 2. The subscriber profile register 360 is stored in the relay administration unit 300, and includes for each subscriber profile data having a subscriber password and global computer network address for each subscriber and a subscriber identification index mapping the PMU subscriber identification module to the subscriber profile data.

Each PMU 100 intermittently broadcasts its characteristic identifier signal as stored in the subscriber identification module 130. The access host processors 200 receive PMU identifier signals from PMUs 100 that are within their respective ranges. If two or more access host processors 200 receive the identifier signal from the same PMU 100, a contention program distributed among the access host processors assigns one of the access host processors 200 to control all communication with the PMU 100, and directs other AHPs 200 to ignore that PMU 100.

See FIG. 2A. The access host processor 200 is pre-loaded with a set of master application classes 240 to carry out generally-required messaging and other applications under the control of the invention's connection and session management software 220, 250. The access host processor's applications 240 appear to the rest of the world as normal PC-resident applications and services. The AHP's wireless component that connects to the end users is hidden from the worldwide network. The access host processor is connected to the network via a cable modem, a DSL modem, a WAN/LAN, or a regulated wireless connection.

Any interactive data application operating on an AHP may concurrently serve multiple PMUs communicating directly with that AHP.

The access host processor's transceiver 210 uses modified TCP/IP protocols to improve wireless range and reliability for its connections to end users. An access host processor has an end-user range of 1-3.4 miles (can be up to 10 miles line-of-sight) giving it a coverage area of 3.5-10 square miles.

Personal Messaging Unit (PMU)

To an access host processor the invention connects one or more simple portable wireless messaging devices, each called here a personal messaging unit or PMU, for consumers or enterprise users. The simplicity of the PMU, operating as a ‘thin client’, arises from the invention's interface to a wide variety of application programs running in the access host processor. The flexibility and expandability of the access host processor provides for ongoing growth and change in applications serving the thin client in the wireless device. As an example, the invention's software can operate wireless gaming and other evolving applications on the access host processor as called for by users of connected PMUs.

See FIG. 2B. The PMU 100 is a wireless client operating as either a dedicated device or an appropriately licensed and configured transceiver 110 coupled to a PDA. The client application 140 runs the reciprocal element 120 of the Connection Manager 220 (in FIG. 2A) in the access host processor and an I/O and session control element that allows the PMU 100 to toggle among the applications hosted at the access host processor. The PMU also contains the Subscriber Identification Module (SIM) 130 to allow an access host processor to identify the PMU 100 and activate connections and sessions for it.

The PMU's memory stores the client application program 140, messages, data, addresses, and other user information. The PMU's processor runs the client application program 140 for sending and receiving messages via its RF I/O. When the PMU is activated, it continually transmits a PMU identifier signal that is unique for each PMU. Connection speeds are several times that of other SMS-based services, but do not consume the bandwidth required for true broadband. A user can have multiple email and instant messaging client sessions running concurrently.

PMU Embodiment Illustrations

The invention's placement of its application software in the access host processor simplifies the PMU sufficiently to enable a wide variety of PMU embodiments not possible in conventional systems. The following description of possible PMU embodiments is included to illustrate the unique advantages of the invention.

The software and hardware components of the PMU center almost completely around support of user interface connections, and need contain no significant burden of specialized applications or specific interface hardware. This simplicity permits the PMU to be packaged in a wide variety of forms, generally described here to illustrate the power of the invention to enable a range of possible PMU configurations.

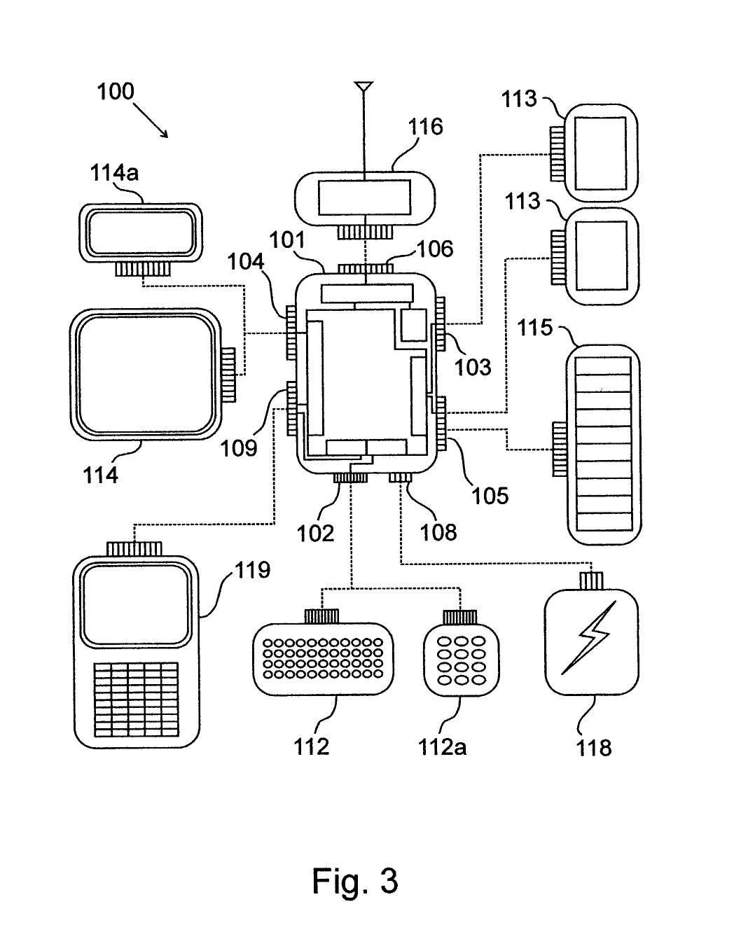

FIG. 3, taken as a whole, presents a range of possible embodiments of the PMU 100 in diagrammatic form. A first embodiment divides the PMU into multiple plug-in components, with its main component called a PMU Primary, or PMUP 101. The PMUP 101 contains the PMU's processor, ROM, memory, ports and associated adapters, and power supply. The ports may include a user-input port 102, a user-display port 104, a link port (for wireless) 106, a power port 108 for recharge or auxiliary power, a memory expansion port 103, and a mass storage expansion port 105. The PMU's plug-in components include a keyboard 112, 112a or some other input device connected via user-input port 102; a display screen 114, 114a connected via user-display port 104; a required wireless transceiver 116 connected via link port 106, a power adapter or battery pack 118 connected via auxiliary power port 108, one or more memory expansion units 113 connected via memory expansion port 103, and a mass storage unit 115 connected via mass storage expansion port 105.

In a second embodiment, if a separate PDA or other device 119 with user input and display capabilities is to be used, the PMUP can connect to it via a separate port 109, eliminating the need for ports 102, 103, 104, and 105. All connections may be made by direct plug-in or through the use of connecting cables.

In a third and simplest embodiment, the PMU comprises only the PMUP 100 and RF input/output components 116 for sending and receiving radio signals. In the third embodiment, the PMUP 100 plugs into a PDA or other handheld device 119 which supplies the user interface and presentation for the PMU's messaging software component.

In a fourth embodiment, physically independent of other devices 119, the PMU has the same components as in the third embodiment, plus a small LCD 114a for message reading and a small set of keys 112a for user input. Menu software facilitates entry of text.

Service Management

See FIG. 2. The service is managed by a standard OSS system, here called a Relay Administration Unit, or RAU 300. The RAU 300 handles provisioning, activation, roaming and service management for the PMUs 100. The RAU 300 stores, maintains, and accesses all user profiles 360 for users associated with the access host processors in its area, and stores, maintains, and accesses its own user home location register (HLR) 370. Once a PMU 100 is provisionally activated, its user self-activates by establishing a personal profile and activating particular messaging services via the invention's web site, connecting to the RAU 300 via an AHP 200 to do so.

Applications

In conventional technology, a process called “mirroring through redirection” uses the subscriber's office PC as an email reflector to reroute incoming email back to a wireless gateway which then sends the mail to the wireless device. This process comprises a “push” connection, where the PC host, under the control of the redirector program, “pushes” data (messages) to the wireless device. This conventional approach contrasts with a “pull” connection, where the device requests data from the PC host. In the invention, the PMU “pulls” data from the host (or one of a plurality of hosts) and, in effect, “spoofs” the internet service provider into thinking that a user's PC is present. The ISP sees only the access host processor. The AHP in turn acts as if it is a “smart router” for the PMUs pulling data from it.

An access host processor can run many software applications for each PMU linked to it. Examples include targeted advertisements and targeted coupons stored on the PMU, single-user games using the PMU's display for the carrying user alone; multi-user games using the PMU's display and the PMU's wireless connection through the access host processor to other users; specialized calculator programs for real estate, geopositioning, mileage, orienteering, shopping comparisons, and others; chat programs interfacing with others on the broadband network and on the wireless network; and shopping programs interfacing with vending programs on the broadband network and on the wireless network. The AHP provides advertiser access to any of a variety of customer bases, using the PMU-stored coupons.

Modes of Communication

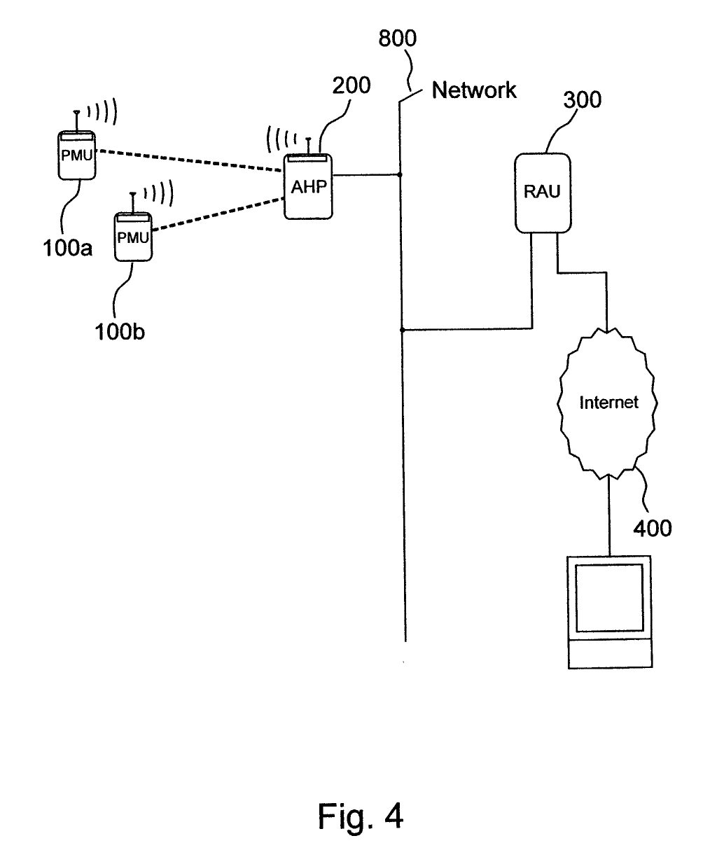

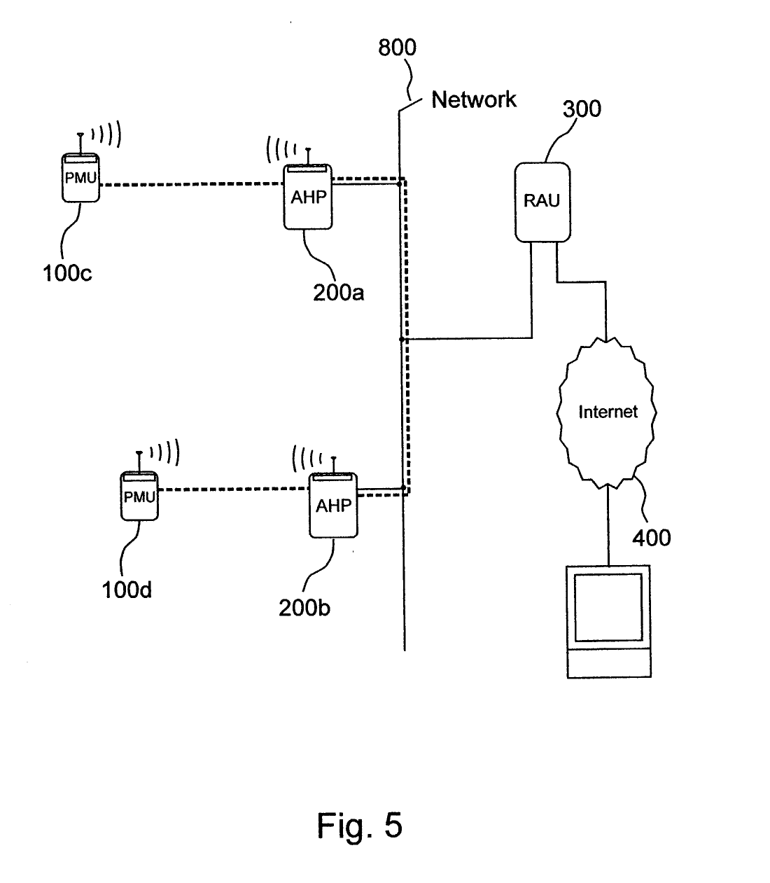

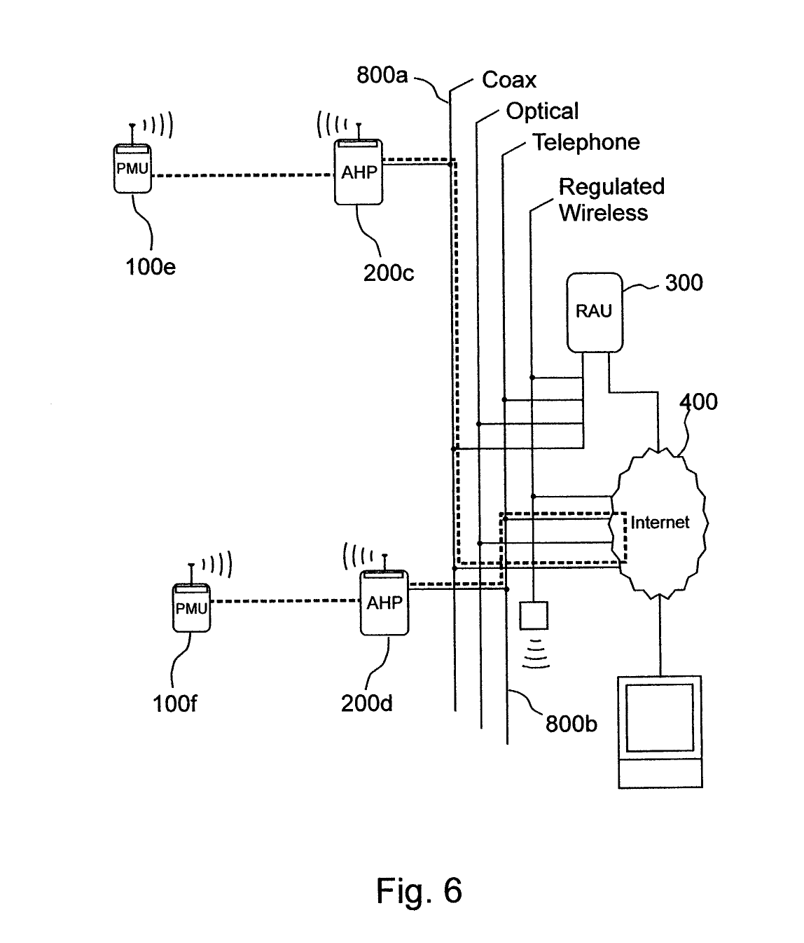

The invention's access host processor communication software provides multiple routing capabilities. PMUs can intercommunicate via AHPs in the following ways. Two PMUs 100a, 100b near each other as in FIG. 4 can communicate directly through a single, shared AHP 200. Two PMUs 100c, 100d farther apart as shown in FIG. 5 can communicate through a pair of AHPs 200a, 200b connected via a single network 800. Two PMUs 100e, 100f on different networks 800a, 800b as shown in FIG. 6 can communicate or through a pair of AHPs 200c, 200d each on a separate network but connected via the Internet 400.

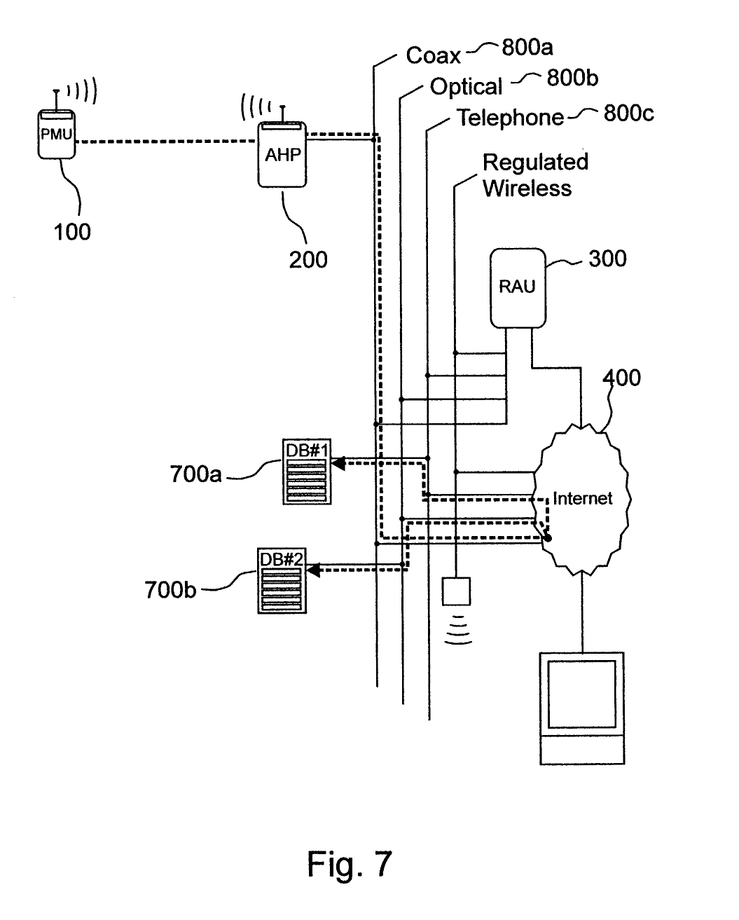

See FIG. 7. Any PMU 100 linking to an AHP 200 on a network 800a connected to the Internet 400 can connects to databases 700a, 700b on different networks 800b, 800c connected to the Internet 400 via a database interface program in the AHP 200. Although not shown here, any database connection may involve multi-tier access.

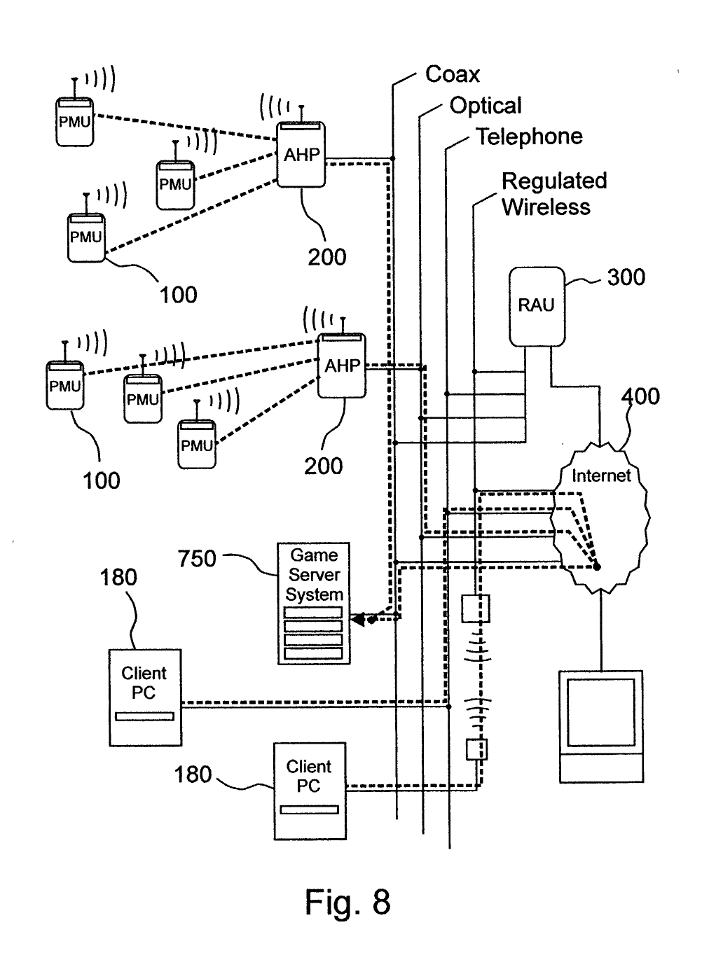

See FIG. 8. A large number of PMUs 100 can connect via multiple AHPs 200 and the Internet 400 into a server system 750, used for, e.g., online interactive games. The server system 750 may also connect with one or more client PCs 180 connected to the Internet, with the client PCs 180 operating in the same way as the PMUs 100 with respect to the server 750.

Application Illustrations

In the invention, shopping programs and vending programs can interact. In one scenario, a vending program serving one or more merchants feeds advertisements via the broadband network to a set of access host processors near the desired sales locations. Each access host processors transmits the advertisements to any PMUs connected to it. The PMUs receive the advertisements as e-mails or messages. In this scenario, the presence of multiple access host processors in one wireless area necessitates resolving which access host processor is to transmit particular advertisements. The invention resolves transmission roles among proximate access host processors, so that a particular PMU receives a specific message only from one AHP. In a variation of the above scenario, such a message may contain a coupon which remains on the PMU, to be redeemed by bringing the PMU into the sending merchant's store or otherwise linking the PMU with the sending merchant's establishment.

Each access host processor has a wireless range of two miles or more. The PMUs have similar ranges. In one embodiment the access host processors are weatherproof devices attached to telephone poles carrying cable television lines, and linked into the cable network. The cable network has a large bandwidth.

In another embodiment the access host processors are distributed in public gathering places: inside a shopping mall, a plaza, a school campus, or an entertainment complex. These access host processors are interconnected by LAN, cable, telephone line, or wireless, and transmit vendor advertisements to PMUs within range of their locations. In a variation of this embodiment, where no LAN or cable connection is available, a “remote” AHP can be slaved to a networked AHP via fixed wireless connection.

In further embodiments, the access host processors are in combinations of cable linkups and public locations. In such embodiments, the access host processors become both the distribution points for merchant information for possible buyers, and the concentration points for social interactions. By adding one or more database tiers to the architecture, the access host processors gain access to shopping patterns for individual users and groups, providing for targeted appeals to users of PMUs based on aggregated shopper purchasing patterns. Such usage makes the invention appealing to merchants, who can then offer PMUs and service applications to shoppers at low cost in order to gain meaningful access to each shopper's attention.

Relay Administration Unit

See FIG. 1. The system is controlled by one or more relay administration units (RAUs) 300, each of which performs service management functions. Each RAU 300 is coupled to all the networks 800 that carry access host processors 200. The RAU 300 is also connected to the Internet 400 or other wide area or local area network. The RAU 300 receives input messages from outside the system, identifies the PMU 100 to whom the message is addressed, and routes the messages to the access host processor 200 that is in control of the addressed PMU 100. The RAU 300 sends messages from inside the system, and routes these outbound messages to the appropriate locations, including access host processors and their associated PMUs elsewhere.

Service Walkthrough

To illustrate the invention's model, the following walkthrough scenario includes device purchase, activation, profile establishment, and wireless connectivity transactions.

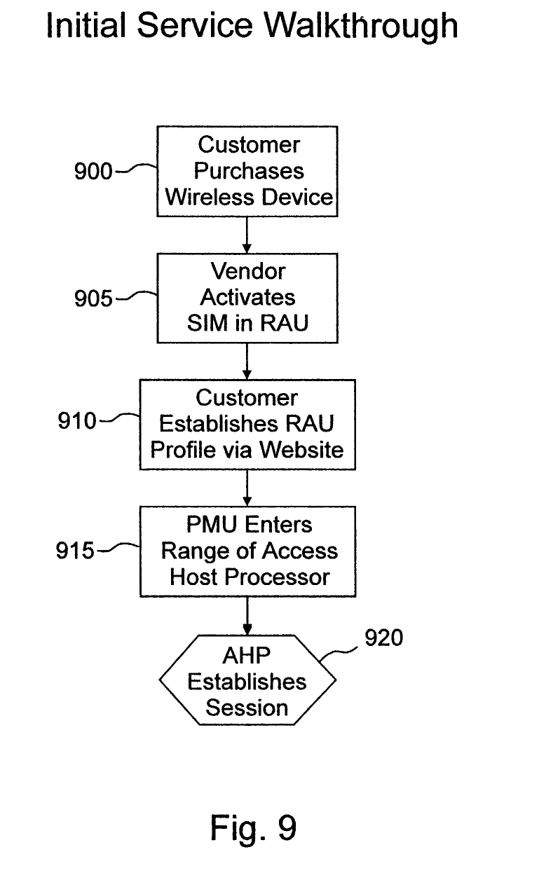

1. See FIG. 9. The consumer purchases (900) a licensed device (PMU) at retail outlet or over the Web. At this time of purchase, the PMU's Subscriber Identification Module (SIM) is activated (905) within the service management component in an RAU.

2. The consumer then establishes (910) a customer profile by accessing a company web site using the SIM code as a PIN, and enters the following information:

ISP(S) with account and login information

Email account(s) with passwords, name and reply-to address(es)

IM account(s) with Screen Name(s)/Number(s) Buddy List(s).

3. The subscriber brings (915) the fully activated PMU within range of an access host processor. This permits the AHP to establish (920) the session.

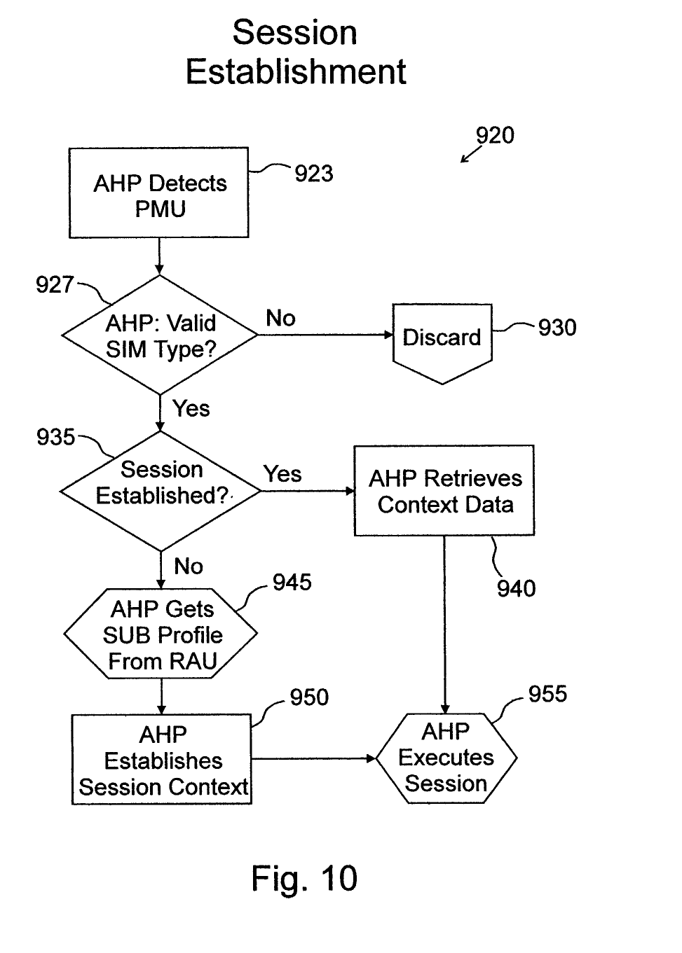

4. See FIG. 10 for the process of session establishment 920. The access host processor (via the Connection Manager) detects (923) the PMU, senses that a SIM is present in the device, and validates (927) the SIM type. If the SIM type is not valid, the AHP discards (930) the process. If the SIM type is valid, the AHP determines (935) whether it has an already-established session running for the SIM. If so, the AHP retrieves (940) its context data and executes (955) the session. If not, the AHP forwards the SIM to the RAU to get (945) the SUB profile from the RAU, establishes (950) the session context, and executes (955) the session.

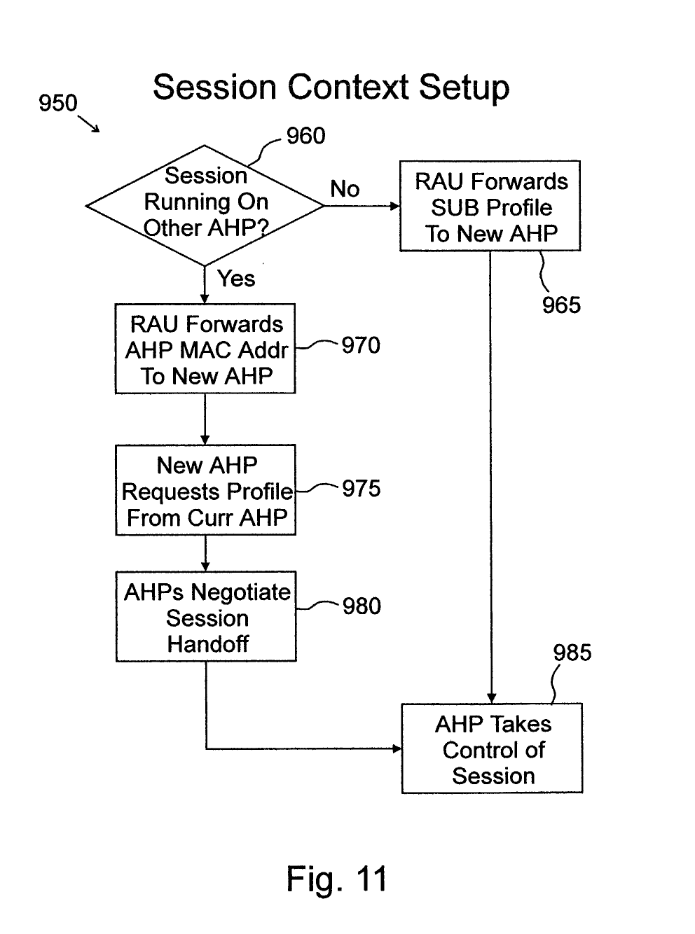

5. See FIG. 11 for the process 950 of setting up session context. The RAU checks (960) to see if a session for that user is already in progress through another access host processor. If not, it forwards (965) the profile information to the requesting access host processor and instructs it to take control (985) of the session. If a session is already in progress, it forwards (970) the MAC address of the current access host processor to the requesting access host processor which requests (975) profile and session context information from the current access host processor. The two access host processors negotiate (980) a session handoff when appropriate, and the new AHP takes control (985 of the session.

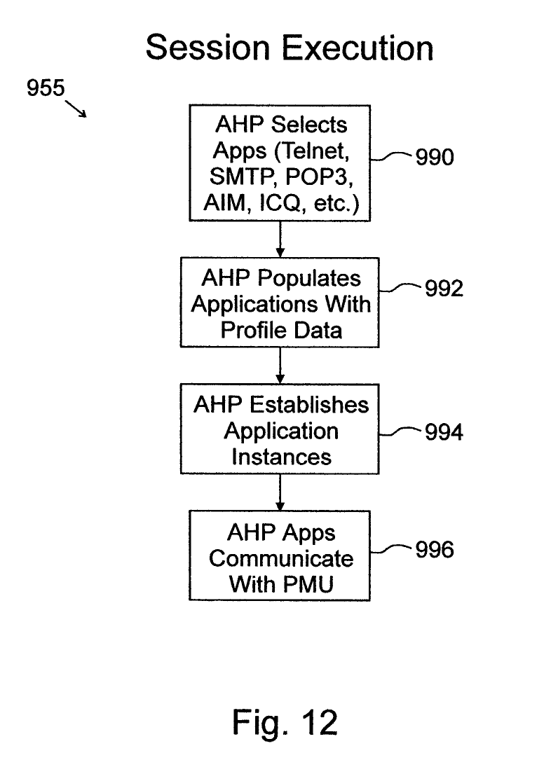

6. See FIG. 12 for the process of session execution. The access host processor initiates a user session by selecting (990) appropriate applications (e.g., Telnet, SMTP, POP3, AIM, ICQ, etc.), populating (992) each application with the appropriate profile information to run the session, and establishing (994) an instance of each appropriate application. The AHP's applications then communicate (996) with the PMU.

7. The access host processor receives input data and control from the wireless appliance (PMU) which allow the access host processor to control the various application instances assigned to the user. It in turn transmits received data from the application instances to the PMU for display to the user.

Since user applications run on a host processor with a direct high speed connection to the backbone, completely new services can be offered to subscribers via a relatively straightforward download to the access host processor. No download or upgrade to the PMUs is required. This simplifies greatly the task of changing the invention's content to meet future needs.

By deploying in this fashion, the invention offers true location-based services to the retailing and hospitality segments of the economy. By agreeing to operate access host processors in their establishments, retailers, restaurants, and other establishments may introduce targeted advertising to the community of PMU users. Pinpoint targeting is possible based on information such as age and gender, contained in the Subscriber Profile. This information allows an establishment to present a subscriber with tightly targeted offers. A simple ad server can be directly connected to one or many access host processors to allow site-by-site ad customization if desired.

Operation of the Invention

Expanding on the service walkthrough shows more detail of the invention's steps of operation. To connect PMUs to the access host processors (AHPs) and server computers, and operate the system, the invention:

1. When setting up a PMU, installs a thin client user interface program in the PMU;

2. When setting up PMUs and AHPs, installs communications programs for connecting each PMU to an AHP, by: installing a connection manager program in each PMU, for connecting the PMU to one or more AHPs; installing client application programs and a connection manager program and session manager program in the AHP, for connecting the first AHP to one or more PMUs; and installing a routing program in the first AHP to route PMU messages;

3. When setting up an AHP, connects the AHP to a network;

4. Connects a PMU to the AHP, by: broadcasting continually an identification code from the PMU, receiving the PMU's identification code at the AHP, verifying at the AHP that the PMU session may be started, and connecting the PMU to the validating AHP, and maintaining the connection between the PMU and the network of AHPs;

5. Accepts requests at the AHP from the PMU user at a PMU connected to the AHP;

6. Executes an application program in the AHP. in reaction to the requests from the PMU user; and

7. Sends responses from the AHP to the PMU of the requesting PMU user.

In Step 4, verifying at the start of a PMU session entails: forwarding the PMU identification code for the PMU from the AHP to a relay administration unit (RAU), determining at the RAU whether the PMU is active in another session, retrieving profile data for the PMU at the RAU, transferring the profile data for the PMU from the RAU to the AHP, and establishing PMU context data at the AHP for the PMU.

Also in Step 4, maintaining the PMU-AHP network connection entails: monitoring the strength of the PMU identification code broadcast from the PMU in the connected AHP, monitoring the strength of the PMU identification code broadcast from the PMU in one or more other AHPs, and when the connected AHP can no longer communicate with the PMU and a second AHP can communicate with the PMU, connecting the PMU to the second AHP and disconnecting the PMU from the first AHP.

In Step 6, executing an application program in the AHP for a PMU user may entail any of the following: 1) sending PMU user requests from the AHP to one or more server computers and receiving responses to PMU user requests at the AHP from the server computers; 2) sending PMU user requests from the connected AHP to a second AHP and receiving responses to PMU user requests at the connected AHP from the second AHP; or 3) sending PMU user requests from the AHP to a second PMU also connected to that AHP and receiving responses to PMU user requests at the first AHP from the second PMU.

To transmit a message to one or more wireless devices (PMUs) via one or more access host processors (AHPs), the invention:

1. Determines the geographic locations of one or more AHPs;

2. Selects one or more AHPs in a desired geographic area;

3. Sends the message from an originator to the selected AHPs, where the originator may be another AHP, a PMU user, or a computer connected to the Internet;

4. In each one of the selected AHPs, determines the identity of each PMU to receive the message from the one of the selected AHPs;

5. In each one of the selected AHPs, transmits the message to each PMU identified to receive the message from the one of the selected AHPs. In Step 4, determining the identity of each PMU to receive the message entails: matching message content with user profile data for the PMU; if user profile data indicates that message content is acceptable to the user and/or the sender, identifies the PMU to receive the message.

Access Point Deployment

Access host processors can be located anywhere that an always-on connection to an ISP can be maintained. These include:

1. On Cable plant with Line Distribution Amplifiers or Addressable Taps,

2. On copper LEC plant with G.SHDSL capability,

3. On copper plant at a residential or business termination point.

In addition, access host processors can be installed in residences or businesses that have an existing permanent Internet connection of any sort. Access Points can be centrally managed despite being connected in multiple ways, allowing for broad buildout using parallel strategies.

These access host processors are simple to install and provision. The company can purchase access either directly from facilities-based broadband ISPs or directly from their customers, or the ISPs can build out the access points themselves for a share of subscription revenues within their geographies. The option exists for these ISPs to become service resellers within their coverage footprint.

The invention's infrastructure and service deployment model represents an approach to deploying wireless data services which is free of the multiple constraints associated with other existing and planned services. The invention delivers the promise of universal, multi-service wireless messaging at a fraction of current and estimated future delivery costs. It furthermore delivers multiple interactive “3G-like” applications over a currently-available infrastructure.

What is claimed is:

1. A communication system among a plurality of subscribers employing a computer network, comprising:
(a) at least one access host processor (AHP) operably connected to the computer network, the access host processor comprising a main memory, a storage device, at least one interactive data application, a visitor profile register, and a connection manager;
(b) a host wireless data transceiver operably connected to the access host processor;
(c) at least one remote portable (handheld) data device (PMU), the data device comprising a user interface for presenting data to a user and entering data from the user, a subscriber identification module for identifying the user, a distributed portion of the connection manager, and a client wireless data transceiver for selective communicating with the host wireless data transceiver; and
(d) a subscriber profile register connected to the access host processor, the subscriber profile register selected to authenticate the subscriber identification module to (i) permit sustained communication between the host access processor and the remote portable data device, (ii) populate the visitor profile register with subscriber specific data and (iii) create on the access host processor a virtual instance of the interactive data application corresponding to the populated visitor profile register.

2. The communication system of claim 1, further comprising a plurality of access host processors.

3. The communication system of claim 2, wherein each of the plurality of access host processors includes a session manager controlling the initiation, maintenance, and termination of sustained connections between the remote portable data device and the access host processor.

4. The communication system of claim 3, wherein a first session manager in a first access host processor communicates with a second session manager in a second access host processor in accordance with the subscriber profile register to migrate connectivity of a portable data device between the first access host processor and the second access host processor.

5. The communication system of claim 1, wherein the interactive data application is selected to be shared among multiple portable data devices operably and simultaneously connected to the access host processor.

6. The communication system of claim 2, further comprising a connection manager in each of the plurality of access host processors.

7. The communication system of claim 6, wherein the connection manager authenticates a subscriber identification module from a remote portable data device prior to forwarding the subscriber identification module to the subscriber profile register.

8. The communication system of claim 1, further comprising a data modem operably connected to the access host processor and the global computer network.

9. The communication system of claim 1, further comprising a transport layer program operating in the access host processor to move data to and from the global computer network.

10. The communication system of claim 1, further comprising a data presentation and display manager in each of the plurality of remote portable data devices.

11. The communication system of claim 10, wherein the data presentation and display manager controls the user interface for inputting and displaying data.

12. The communication system of claim 1, wherein the subscriber profile register includes a subscriber profile data having a subscriber password and global computer network address for each subscriber and a subscriber identification index mapping the subscriber identification module to the subscriber profile data.

13. A hybrid messaging system comprising:
(a) a plurality of personal messaging units (PMUs), each with a cellular radio transceiver for receiving and sending messages over an unregulated radio spectrum to a relay unit, means for creating messages, and means for presenting messages to a user;
(b) a plurality of access host processors (AHPs), each AHP further comprising: (i) a cellular radio transceiver for receiving and sending messages over an unregulated radio spectrum to PMUs and connected to a broadband network for receiving messages and for relaying messages from the PMUs to sites on the broadband network, and (ii) one or more application program classes for carrying out messaging and other applications on behalf of a requesting PMU.

14. The hybrid messaging system of claim 13 wherein the broadband network is one or a combination of networks selected from the group consisting of coaxial cable networks, fiber optical networks, regulated wireless networks, and switched access telephone networks.

15. The hybrid messaging system of claim 13 wherein the unregulated radio spectrum is one or more of the frequency bands selected from the group consisting of the unregulated frequency bands at 902-928 MHz, 2400-2483.5 MHz, and 5725-5850 MHz.

16. A portable handheld data device (PMU), the data device comprising:
(a) a user interface program for presenting data to a user and entering data from the user;
(b) a subscriber identification module for identifying the user of the data device;
(c) a distributed portion of a connection manager program for connecting the data device to an access host processor;
(d) a thin-client application program for passing information between a user of the data device and the access host processor; and
(e) a client wireless data transceiver for selective communicating with the host wireless data transceiver.

17. The portable data device of claim 16, wherein the thin-client application further comprises:
(a) an input control element for data entry by the user;
(b) an output control element for data display to the user; and
(c) a session control element for initiation, maintenance, and termination of sustained connections between the data device and any of one or more access host processors.

18. A method of connecting one or more wireless devices (PMUs) to a network of access host processors (AHPs) and server computers, comprising the steps of:
(a) installing a thin client user interface program in each PMU;
installing communications programs for connecting one or more PMUs operably to a first AHP;
(b) connecting the first AHP operably to a network;
(c) connecting a PMU operably to the first AHP;
(d) accepting requests at the first AHP from the PMU user at a PMU connected to the first AHP;
(e) executing an application program in the first AHP in reaction to the requests from the PMU user; and
(f) sending responses from the first AHP to the PMU of the requesting PMU user.

19. The method of claim 18, wherein the step of installing communications programs for connecting each PMU operably to a first AHP further comprises the steps of:
(a) installing client application programs in the first AHP;
(b) installing a connection manager program in the first AHP, for connecting the first AHP to one or more PMUs;
(c) installing a connection manager program in each PMU, for connecting the PMU to one or more AHPs;
(d) installing a session manager program in the first AHP, for connecting the first AHP to one or more PMUs; and
(e) installing a routing program in the first AHP to route messages to and from each connected PMU.

20. The method of claim 18, wherein the step of connecting a PMU operably to the first AHP further comprises the steps of:
(a) broadcasting continually an indentification code from the PMU;
(b) receiving the PMU's identification code at the first AHP;
(c) verifying at the first AHP that the PMU session may be started;
(d) connecting the PMU to the validating first AHP; and
(e) maintaining the connection between the PMU and the network of AHPs.

21. The method of claim 20, wherein the step of verifying at the first AHP that the PMU session may be started further comprises the steps of:
(a) forwarding to a relay administration unit (RAU) from the first AHP the PMU identification code for the PMU;
(b) determining at the RAU whether the PMU is active in another session;
(c) retrieving profile data for the PMU at the RAU;
(d) transferring the profile data for the PMU from the RAU to the AHP; and
(e) establishing PMU context data at the AHP for the PMU.

22. The method of claim 20, wherein the step of maintaining the connection between the PMU and the first AHP further comprises the steps of:
(a) in the first AHP, monitoring the strength of the PMU identification code broadcast from the PMU;
(b) in a second AHP, monitoring the strength of the PMU identification code broadcast from the PMU;
(c) when the first AHP can no longer communicate operably with the PMU and the second AHP can communicate operably with the PMU, connecting the PMU operably to the second AHP and disconnecting the PMU from the first AHP.

23. The method of claim 20, wherein the step of executing an application program in the first AHP further comprises the steps of:
(a) sending PMU user requests from the first AHP to one or more server computers; and
(b) receiving responses to PMU user requests at the first AHP from the server computers.

24. The method of claim 20, wherein the step of executing an application program in the first AHP further comprises the steps of:
(a) sending PMU user requests from the first AHP to a second AHP; and
(b) receiving responses to PMU user requests at the first AHP from the second AHP.

25. The method of claim 20, wherein the step of executing an application program in the first AHP further comprises the steps of:
(a) sending PMU user requests from the first AHP to a second PMU; and
(b) receiving responses to PMU user requests at the first AHP from the second PMU.

26. A method of transmitting a message to one or more wireless devices (PMUs) via one or more access host processors (AHPs), comprising the steps of:
(a) determining the geographic locations of one or more AHPs;
(b) selecting one or more AHPs in a desired geographic area;
(c) sending the message from an originator to the selected AHPs;
(d) in each one of the selected AHPs, determining the identity of each PMU to receive the message from the one of the selected AHPs;
(e) in each one of the selected AHPs, transmitting the message to each PMU identified to receive the message from the one of the selected AHPs.

27. The method of claim 26 wherein the step of determining the identity of each PMU to receive the message further comprises the steps of:
(a) matching message content with user profile data for the PMU;
(b) if user profile data indicates that message content is acceptable to the user, identifying the PMU to receive the message.

28. The method of claim 26 wherein the step of determining the identity of each PMU to receive the message further comprises the steps of:
(a) matching message content with user profile data for the PMU;
(b) if user profile data indicates that user profile is acceptable to the sender, identifying the PMU to receive the message.

29. The method of claim 26 wherein the step of sending the message from an originator to the selected AHPs further comprises the step of sending the message from an AHP to the selected AHPs.

30. The method of claim 26 wherein the step of sending the message from an originator to the selected AHPs further comprises the step of sending the message from a computer operably connected to the Internet to the selected AHPs.

31. The method of claim 26 wherein the step of sending the message from an originator to the selected AHPs further comprises the step of sending the message from a PMU to its connected AHP for transmission to the selected AHPs.
